(19) United States
(12) Patent Application Publication
(10) Pub. No.: US 2005/0100346 A1
(43) Pub. Date: May 12, 2005

(54) Optical transmitter for use in high-density wavelength division multiplexing (WDM) optical transmission system

(76) Inventors: Hoon Kim, Suwon-si (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(21) Appl. No.: 10/864,840

(22) Filed: Jun. 9, 2004

(30) Foreign Application Priority Data
Nov. 12, 2003 (KR) 2003-79866

(51) Int. Cl. H04B 10/04

(52) U.S. Cl. 398/188

(57) ABSTRACT

An optical transmitter for use in high-density WDM (Wavelength Division Multiplexing) optical transmission system generates an RZ-AMI (Return to Zero—Alternate Mark Inversion) signal which contains not only high reception sensitivity suitable for a high-density WDM optical transmission system, but also a narrow spectrum bandwidth. The transmitter includes a precoder for coding an input binary-data electric signal, a modulation drive amplifier for amplifying the coded signal, a light source for generating an optical carrier signal, a first optical modulator for modulating a phase of the optical carrier signal upon receiving the amplified signal from the amplifier, a second optical modulator for modulating an output signal of the first optical modulator into an RZ (Return to Zero) signal, and an optical filter for filtering an output signal of the second optical modulator to tailor the output signal for a predetermined bandwidth.

### CLAIM OF PRIORITY

This application claims priority to an application entitled “OPTICAL TRANSMITTER FOR USE IN HIGH-DENSITY WAVELENGTH DIVISION MULTIPLEXING (WDM) OPTICAL TRANSMISSION SYSTEM,” filed in the Korean Intellectual Property Office on Nov. 12, 2003 and assigned Serial No. 2003-79866, the contents of which are hereby incorporated herein by reference.

### BACKGROUND OF THE INVENTION

1. Field of the Invention

The present invention relates to an optical transmitter, and more particularly to an optical transmitter for generating an RZ-AMI (Return to Zero—Alternate Mark Inversion) signal which contains not only high reception sensitivity suitable for a high-density Wavelength Division Multiplexing (WDM) optical transmission system, but also a narrow spectrum bandwidth.

2. Description of the Related Art

Typically, an Alternate Mark Inversion (AMI) modulation scheme loads information on the intensity of an optical signal, and at the same time inverts a phase of the optical signal for every bit of 1. Particularly, an RZ (Return to Zero)-AMI signal moves its energy in the range from one energy ‘0’ to the other energy ‘1’ for every bit of 1 and returns to the initial energy ‘0’ in a same manner as in an RZ signal, such that the RZ-AMI signal can be indicative of such optical signal's intensity. Therefore, the RZ-AMI signal has the same signal intensity as that of the RZ signal, such that it contains advantages of the RZ modulation scheme (e.g., a transmission system having a data transfer rate of more than 20 Gb/s which is very resistant to nonlinearity of optical fibers) and encounters phase conversion for every bit of 1, resulting in a limited carrier frequency component and a strong resistance to Brillouin nonlinear effects. Although the RZ-AMI signal adapts the RZ modulation scheme, there is no DC frequency component in the RZ-AMI signal, such that a signal modulation scheme of a reception end can easily be converted into a VSB (Vestigial SideBand) modulation scheme, resulting in an increased allowable value in association with the optical fiber's dispersion.

FIG. 1 is a block diagram illustrating a conventional RZ-AMI optical transmitter. FIG. 2A is a view illustrating eye-diagrams of an output signal of the RZ-AMI optical transmitter shown in FIG. 1. FIG. 2B is a view illustrating optical spectrums of the RZ-AMI optical transmitter shown in FIG. 1.

Referring to FIG. 1, the conventional RZ-AMI optical transmitter 100 includes a precoder 101, four modulation drive amplifiers 102, 103, 109, 110, two low pass filters (LPFs) 104, 105, a laser source 106, and two Mach-Zehnder-interferometer-type optical intensity modulators (MZ MODS) 107, 108.

In operation, binary input data “Data” is encoded by the precoder 101. Generally, the precoder 101 can be implemented with a 1-bit delay and an XOR (exclusive-OR) logic gate. The coded binary data is transmitted to the LPFs 104, 105 via the two modulation drive amplifiers 102, 103, respectively. The reference character Q shown in FIG. 1 is indicative of an inversion signal of a signal Q. Although the LPFs 104, 105 function as ideal cosine² filters, respectively, they can be configured to approximate a Bessel-Thomson Filter. Provided that individual bandwidths of the LPFs 102, 103 are each equal to a specific bandwidth of 3-dB equal to ¼ the transfer rate of the binary data signal (e.g., 2.5 GHz filter in case of 10 Gb/s data), the binary signals generated from the LPFs 104, 105 are converted into band-limited ternary signals, respectively. The band-limited ternary signals are transmitted to the MZ MOD 107, such that the MZ MOD 107 modulates the carrier wave generated from the laser source 106 into an optical duo-binary signal. In this case, a bias of the MZ MOD 107 is positioned at a null point corresponding to a minimum value of a characteristic transfer function. The generated optical duo-binary signal is transmitted to the second MZ MOD 108. The second MZ MOD 108 is driven by a sinusoidal wave equal to half of a signal clock frequency. The bias of the MZ MOD 108 is positioned at the null point indicative of a minimum value of a characteristic transfer function, such that the second MZ MOD 108 can generate a carrier-suppressed RZ (CS-RZ) signal. The second MZ MOD 108 is adapted to invert a signal phase for every bit. The aforementioned conventional RZ-AMI optical transmitter 100 is composed of an optical duo-binary transmitter and a CS-RZ generator, and is characterized as DCS-RZ (Duo-binary-Carrier-Suppressed RZ).

Referring to the output signal's eye diagrams shown in FIG. 2A, the conventional RZ-AMI optical transmitter positions a sinusoidal signal at a frequency double the data transfer rate at a specific level value of 0, resulting in deteriorated reception sensitivity compared to a return-to-zero on-off key (RZ-OOK) signal. In other words, the RZ-AMI signal generated from the conventional optical transmitter is very sensitive to noise, resulting in deterioration of a maximum transfer distance. Also, the conventional optical transmitter generates a duo-binary signal on the basis of a ternary signal and generates an RZ-AMI signal using the generated duo-binary signal. Disadvantageously, transmitter performance varies with the pattern length of the received electric signal.

Furthermore, the conventional RZ-AMI optical transmitter temporally uses an RZ modulation scheme as can be seen from the output signal's spectrums shown in FIG. 2B, and requires a wide bandwidth, such that it cannot acquire high spectrum efficiency (e.g., 0.6 bit/s/Hz).

### SUMMARY OF THE INVENTION

The present invention has been made in view of the above problems, and it is an object of the present invention to provide an optical transmitter for generating an RZ-AMI signal which contains not only high reception sensitivity but also a narrow spectrum bandwidth, such that it can improve performance of a high-density Wavelength Division Multiplexing (WDM) long-distance optical transmission system.

In accordance with the present invention, the above and other objects can be accomplished by the provision of an optical transmission apparatus for use in a high-density Wavelength Division Multiplexing (WDM) optical transmission system, that includes a precoder for coding an input binary-data electric signal, a modulation drive amplifier for amplifying the coded signal, a light source for generating an optical carrier signal, a first optical modulator for modulating a phase of the optical carrier signal upon receiving the amplified signal from the modulation drive amplifier, a second optical modulator for modulating an output signal of the first optical modulator into an RZ (Return to Zero) signal, and an optical filter for filtering an output signal of the second optical modulator to tailor the output signal to a predetermined bandwidth.

### BRIEF DESCRIPTION OF THE DRAWINGS

The above and other objects, features and other advantages of the present invention will be more clearly understood from the following detailed description taken in conjunction with the accompanying drawings, in which the same or similar elements are denoted by the same reference numerals throughout the several views:

FIG. 1 is a block diagram illustrating a conventional RZ-AMI optical transmitter;

FIG. 2A is an exemplary view illustrating eye-diagrams of an output signal of the RZ-AMI optical transmitter shown in FIG. 2A;

FIG. 2B is an exemplary view illustrating an optical spectrum of the output signal of the RZ-AMI optical transmitter;

FIG. 3 is a block diagram illustrating the RZ-AMI optical transmitter in accordance with a preferred embodiment of the present invention;

FIGS. 4A, 4B, and 4C are exemplary views illustrating the operation principles of the RZ-AMI optical transmitter shown in FIG. 3;

FIG. 5 is an exemplary graph illustrating a reception sensitivity simulation result between the conventional RZ-AMI signal and the inventive RZ-AMI signal; and

FIG. 6 is an exemplary view illustrating an optical spectrum of the RZ-AMI signal generated from the optical transmitter.

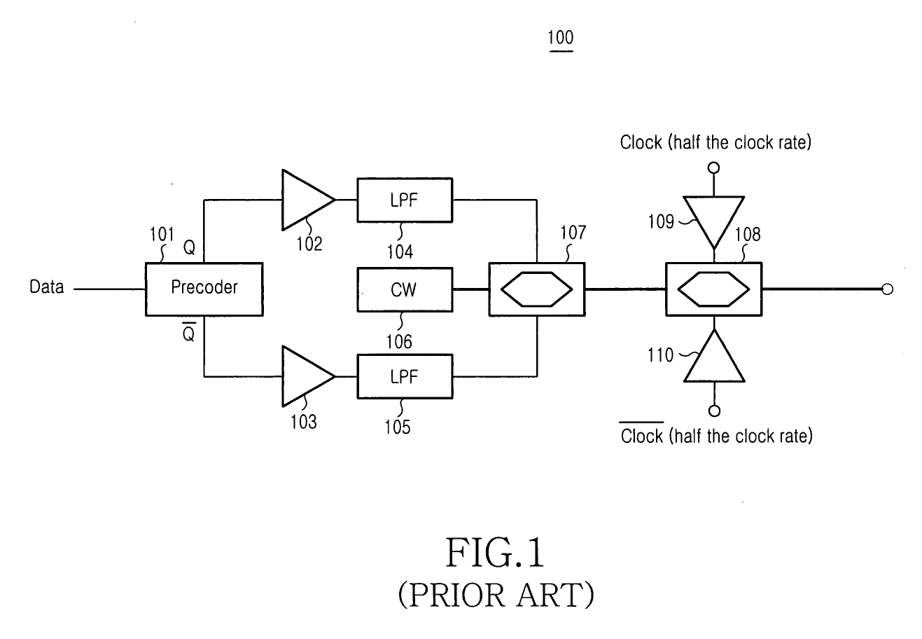

### DETAILED DESCRIPTION

Preferred embodiments of the present invention are described in detail below with reference to the annexed drawings. In the following description, details of known functions and configurations incorporated herein are omitted for clarity of presentation.

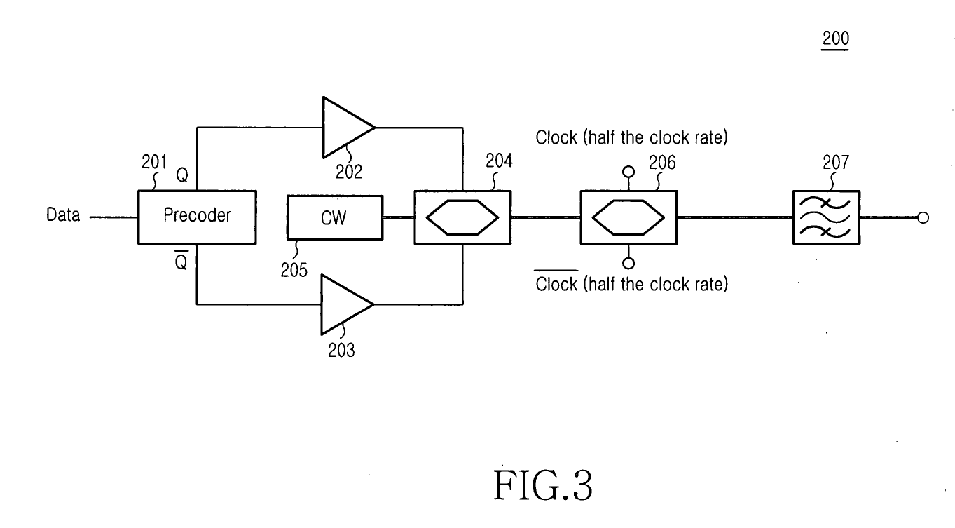

FIG. 3 is a block diagram showing, by way of illustrative and non-limitative example, the RZ-AMI optical transmitter 200 in accordance with a preferred embodiment of the present invention. The transmitter 200 includes a precoder 201, modulation drive amplifiers 202, 203, a CW laser 205, first and second MZ MODs 204, 206, and an optical filter 207.

The precoder 201 codes an input binary data signal, and can be implemented with a 1-bit delay and an XOR (exclusive-OR) logic gate.

The modulation drive amplifiers 202, 203 amplify the coded binary data such that they can operate the modulator.

The CW laser 205 outputs an optical carrier signal as a light source.

The first and second MZ MODs 204, 206 are adapted to modulate the phase of the optical carrier signal upon receiving a drive signal applied to an electrode, and adjust a modulation index indicative of a modulation degree, and thereby adjust a phase modulation degree. Typically, the MZ MOD is classified into a Z-cut type MZ MOD having a dual arm and an X-cut type MZ MOD having a single arm. Although the present invention discloses the Z-cut type MZ MOD for illustrative purposes, implementation with the X-cut MZ MOD having the single arm is within the intended scope of the invention.

The optical filter 207 receives a phase-modulated signal, and filters the received phase-modulated signal to within a prescribed bandwidth. The optical filter 207 can be implemented with either an AWG (Arrayed Waveguide Grating)—based WDM (Wavelength Division Multiplexer) or an interleaver. The interleaver acts as an element for separating/combining even and odd channels in a WDM optical transmission system. In particular, the interleaver multiplexes the even channels using a directional coupler, multiplexes the odd channels using a WDM, and combines the even and odd channels using an interleaver having a bandwidth equal to 0.7 times a signal modulation rate in such a way that it can implement a transmission end. The optical filter 207 acts as a narrowband optical filter, and its bandwidth is equal to 0.7 times a signal modulation rate.

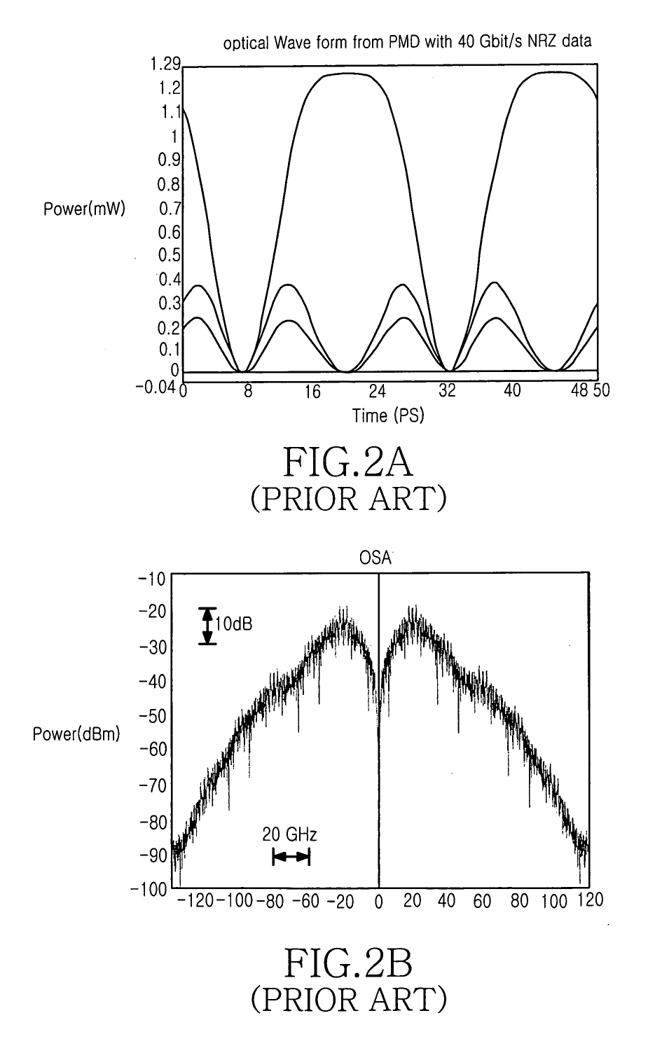

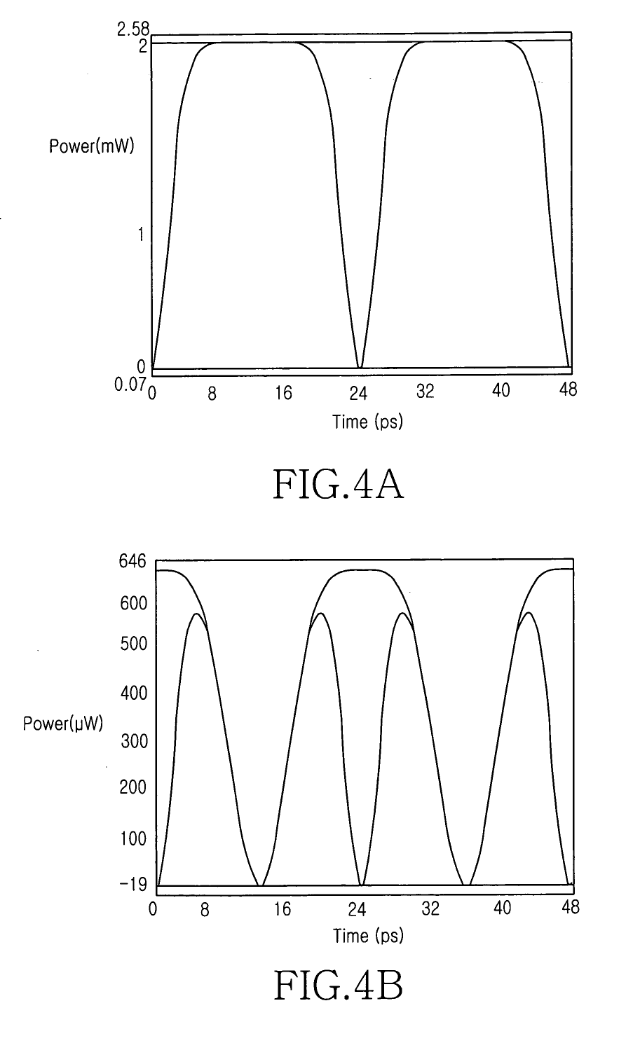

Operationally and referring to FIG. 3, a binary data signal “Data” coded by the precoder 201 is transmitted to the modulation drive amplifiers 202, 203. The amplified signals are applied to the first MZ MOD 204. The reference character Q shown in FIG. 3 is indicative of an inversion signal of a signal Q. The inversion signal Q is applied to positive(+) and negative(−) electrodes of the first MZ MOD 204 having a dual arm. In order to operate the first MZ MOD 204, the bias of the first MZ MOD 204 must be positioned at the null point indicative of a minimum characteristic transfer function, and the magnitude of a signal applied to the first MZ MOD 204 must be equal to double the half-wave voltage Vπ of the optical modulator. Under these operating conditions, the first MZ MOD 204 acts as a phase modulator, and modulates a phase of an optical carrier signal generated from the CW laser 205. FIGS. 4A, 4B, 4C are exemplary views illustrating the operation principles of the RZ-AMI optical transmitter shown in FIG. 3. FIG. 4A shows output eye-diagrams of the first MZ MOD 204. The phase-modulated signal generated from the first MZ MOD 204 is transmitted to the second MZ MOD 206. An electric signal for operating the second MZ MOD 206 is indicative of a sinusoidal signal at half the signal clock frequency, and is delayed by a half bit compared to the phase-modulated signal, such that the output signal of the second MZ MOD 206 is shown in FIG. 4B. The signal shown in FIG. 4B is transmitted to the narrowband optical filter 207. A bandwidth of the optical filter 207 is equal to 0.7 times a binary data transfer rate, and an eye-diagram of a signal generated from the optical filter is shown in FIG. 4C. Comparing the eye-diagram of FIG. 4C with the output signal (i.e., FIG. 2A) of the conventional RZ-AMI optical transmitter 100, it is seen that ripple components are greatly restricted in a specific level of 0 and a duty rate of the RZ signal is greatly reduced, such that an output signal of the RZ-AMI transmitter 200 features high reception sensitivity due to the aforementioned characteristics.

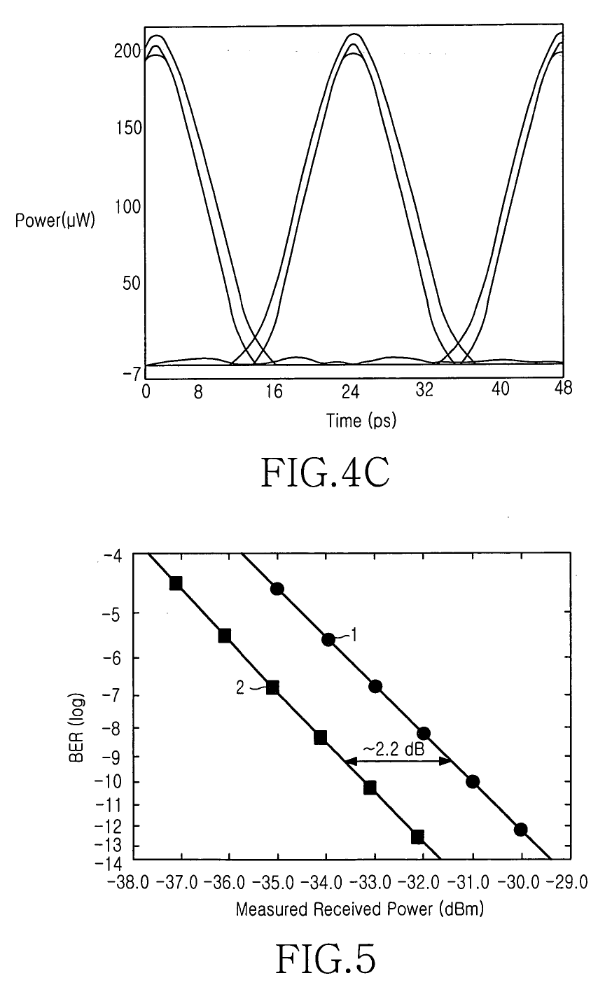

FIG. 5 is an exemplary graph of simulation results comparing reception sensitivity of the conventional RZ-AMI signal 1 with that of the inventive RZ-AMI signal 2. The reception sensitivity is indicative of a power level of an optical signal needed for a 10⁻⁹ BER (Bit Error Ratio). The lower the reception sensitivity, the higher the signal strength to optical noise. Referring to the simulation result of FIG. 5, the RZ-AMI signal of the present invention has reception sensitivity of about 33.8 decibels per milliwatt (dBm) whereas the conventional RZ-AMI signal (1) contains reception sensitivity of about −31.6 dBm. The RZ-AMI signal of the present invention is accordingly better than the conventional RZ-AMI signal by a specific reception sensitivity gain of 2.2 dB. This reception sensitivity gain of 2.2 dB is indicative of transmission distance increment of about 20% in a long-distance transmission system.

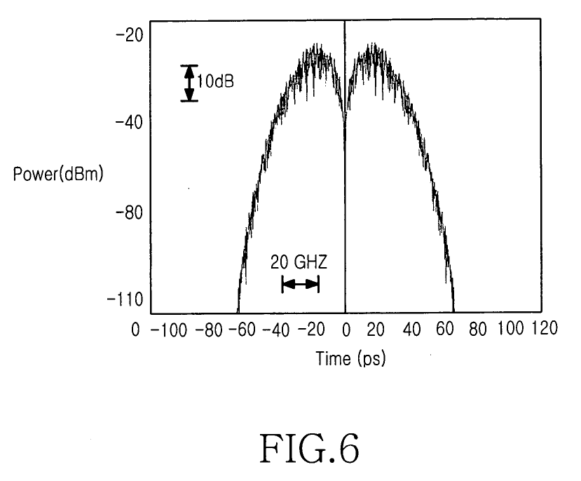

FIG. 6 is an exemplary view illustrating an optical spectrum of the RZ-AMI signal generated from the optical transmitter 200. As can be seen from FIG. 6, signal bandwidth is reduced in comparison to the conventional art shown in FIG. 2B. Due to this signal bandwidth reduction, the WDM optical transmission system can accommodate many more channels within a given bandwidth.

As apparent from the above description, the optical transmitter of the present invention acquires not only high reception sensitivity but also high bandwidth use efficiency from the viewpoint of system performance as compared to the conventional optical transmitter.

The optical transmitter of the present invention does not require an LPF generating a duo-binary signal, and adapts a narrowband optical filter implemented with an AWG-type WDM. The narrowband optical filter is located to the rear of the second MZ MOD, such that the optical transmitter can be economically applied to the WDM system without system complexity.

The optical transmitter of the present invention, as has been demonstrated above, greatly improves performance of a high-density WDM long-distance optical transmission system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An optical transmission apparatus for use in a high-density Wavelength Division Multiplexing (WDM) optical transmission system, comprising:
a precoder for coding an input binary-data electric signal;
a modulation drive amplifier for amplifying the coded signal;
a light source for generating an optical carrier signal;
a first optical modulator for modulating a phase of the optical carrier signal upon receiving the amplified signal from the modulation drive amplifier;
a second optical modulator for modulating an output signal of the first optical modulator into an RZ (Return to Zero) signal; and
an optical filter for filtering an output signal of the second optical modulator to tailor said output signal to a predetermined bandwidth.

2. The apparatus as set forth in claim 1, wherein each of the first and second optical modulators comprises a Mach-Zehnder-interferometer-type optical intensity modulator (MZ MOD).

3. The apparatus as set forth in claim 2, wherein the Mach-Zehnder-interferometer-type optical intensity modulator (MZ MOD) is a Z-cut type MZ MOD having a dual arm.

4. The apparatus as set forth in claim 2, wherein the Mach-Zehnder-interferometer-type optical intensity modulator (MZ MOD) is an X-cut type MZ MOD having a single arm.

5. The apparatus as set forth in claim 2, wherein the first optical modulator comprises a phase modulator.

6. The apparatus as set forth in claim 2, wherein the first optical modulator has a predetermined bias positioned at a null point corresponding to a minimum value of a modulator transfer characteristic.

7. The apparatus as set forth in claim 2, wherein the first optical modulator receives a predetermined signal having a predetermined magnitude equal to double a half-wave voltage Vz of the first optical modulator.

8. The apparatus as set forth in claim 2, wherein the second optical modulator receives a sinusoidal electric signal whose frequency is equal to half that of a data clock frequency.

9. The apparatus as set forth in claim 8, wherein the sinusoidal electric signal is delayed by a half bit compared to said output signal of the first optical modulator.

10. The apparatus as set forth in claim 2, wherein the optical filter is configured to accommodate a bandwidth equal to 0.5 to 0.9 times a transfer rate of the binary-data electric signal.

11. The apparatus as set forth in claim 2, wherein the optical filter comprises a Wavelength Division Multiplexer (WDM).

12. The apparatus as set forth in claim 1, wherein the first optical modulator comprises a phase modulator.

13. The apparatus as set forth in claim 1, wherein the first optical modulator has a predetermined bias positioned at a null point corresponding to a minimum value of a modulator transfer characteristic.

14. The apparatus as set forth in claim 1, wherein the first optical modulator receives a predetermined signal having a predetermined magnitude equal to double a half-wave voltage Vπ of the first optical modulator.

15. The apparatus as set forth in claim 1, wherein the second optical modulator receives a sinusoidal electric signal whose frequency is equal to half that of a data clock frequency.

16. The apparatus as set forth in claim 15, wherein the sinusoidal electric signal is delayed by a half bit compared to said output signal of the first optical modulator.

17. The apparatus as set forth in claim 1, wherein the optical filter is configured to accommodate a bandwidth equal to 0.5 to 0.9 times a transfer rate of the binary-data electric signal.

18. The apparatus as set forth in claim 1, wherein the optical filter comprises a Wavelength Division Multiplexer (WDM).

19. The apparatus as set forth in claim 1, wherein the optical filter is comprises an interleaver.

20. The apparatus as set forth in claim 1, wherein the precoder is implemented with a 1-bit delay and an XOR (exclusive-OR) logic gate.
